(19) United States
(12) Patent Application Publication
(10) Pub. No.: US 2020/0408328 A1
(43) Pub. Date: Dec. 31, 2020

(54) DEVICES AND METHODS FOR A MECHANICAL AUTOMATIC SHUT-OFF TO FLUID RESERVOIRS

(71) Applicant: People and Products Plumbing, LLC, Franklin, MI (US)

(72) Inventors: Craig Schwarzbek, Grand Rapids, MI (US); Robert Penfil, West Bloomfield, MI (US); Sylvia Penfil, West Bloomfield, MI (US); Howard Brown, Franklin, MI (US); Bruce Skolnik, West Bloomfield, MI (US); Jeff Kaczperski, China Township, MI (US); John Tenbusch, Northville, MI (US); Christopher Roos, Novi, MI (US)

(21) Appl. No.: 17/008,973

(22) Filed: Sep. 1, 2020

Related U.S. Application Data
(63) Continuation-in-part of application No. 15/403,889, filed on Jan. 11, 2017, now Pat. No. 10,760,706.
Application No. 15/403,889 is a continuation of application No. 14/345,085, filed on Mar. 14, 2014, now Pat. No. 9,574,679.
(60) Provisional application No. 61/549,842, filed on Oct. 21, 2011.

(51) Int. Cl. F16K 31/18; F16K 31/32; F16K 21/16

(52) U.S. Cl. CPC F16K 31/18; F16K 31/32; Y10T 137/7439; Y10T 137/0318; F16K 21/16

(57) ABSTRACT

Embodiments for an automatic fluid shut off device having a float disposed in a fluid catch basin attached to a first end of a flexible cable movable in an opposite direction of rising fluid in the catch basin; a second flexible cable end extending to a fluid supply base and terminating adjacent to a restrained spider assembly, the spider assembly configured to be rotationally displaceable upon a force by the second flexible cable end in response to a rising fluid in the catch basin; the spider assembly pivotably connected to a shut-off valve; and the shut off valve retained in an open position while the spider assembly is restrained, and under a rotational force to close the shut-off valve upon activation of the spider valve in response to the force by the second flexible cable end.

This application is a continuation-in-part of U.S. application Ser. No. 15/403,889, filed Jan. 11, 2017, which is a continuation of U.S. application Ser. No. 14/345,085, filed Mar. 14, 2014, which is a U.S. National Phase application filed under 35 U.S.C. § 371 of International Application No. PCT/US2012/061112 filed Oct. 19, 2012, designating the United States, which claims priority from U.S. Provisional Application No. 61/549,842 filed Oct. 21, 2011, all of which are hereby incorporated herein by reference in their entirety.

### FIELD

The embodiments described herein provide fluid shut-off devices and methods, and specifically fluid shut-off devices and methods using mechanical action of a float to activate a spring loaded shut-off valve.

### BACKGROUND

Water damage from leaking water reservoirs, such as hot water tanks, dishwashers, and the like, cause damage to many homes each year. Some devices and methods in the art have been developed to attempt detection and shut-off of water leaks from such reservoirs. These devices are typically complicated, expensive and often require the use electrically powered means to shut off the water supply if a leak is detected. One such system is sold under the trade name FLO-LOGIC of Raleigh, N.C., is dependant on electric power. These types of devices could potentially provide no protection if the electronic means fails or electrical power is interrupted.

Other attempts to provide automatic fluid shut-off capability can include a dissolving component, such as one sold under the trade name WAGS valve by Taco, Inc. of Cranston, R.I. Again, this type of system is complicated, expensive and requires the plumbing be run at floor level. Other complicated, space consuming, inefficient, and cost-ineffective attempts are also known (See generally, U.S. Pat. Nos. 7,665,482, 6,253,785 and 2,724,401).

Accordingly, the known processes to shut off a water supply from a leaking water reservoir provide significant advances in the art, but further advances are possible and desired.

### SUMMARY

The embodiments described below provide mechanical fluid shut-off devices and methods, and specifically fluid shut-off devices and methods using a mechanical action of a float to activate a spring loaded shut-off valve.

In one embodiment, an automatic fluid shut off device is provided having a float disposed in a fluid catch basin attached to a first end of a rod movable in a direction of rising fluid in the catch basin; a second rod end extending to a fluid supply base and terminating adjacent to a restrained latch arm end, the latch arm end configured to be pivotably displaceable upon a force by the second rod end in response to a rising fluid in the catch basin; the latch arm pivotably connected to a shut-off valve; and the shut off valve retained in an open position while the latch arm is restrained, and under a rotational force to close the shut-off valve upon a release of the latch arm in response to the force by the second rod end. The latch arm can be restrained by a latch arm retention notch extending downward and inward at about a 3.5 degree angle.

In some embodiments, an overall buoyancy force of the float can be, for example, up to about 1.5 pounds (about 680 gms) against the latch arm and the rotational force against the shut-off valve is at least about 18 pounds (about 8200 gms).

In some embodiments, the rotation force can be supplied by a torsion spring. The torsion spring can have first and second ends generally in parallel and wherein the first torsion spring can be connected to a handle rotatably attached to the shut-off valve and the second torsion spring end is attached to the base. The torsion spring can be formed from music wire with a diameter of about 0.105 inches (about 2-3 mms).

In some embodiments, the shut-off valve can be a ¾″ (about 19 mms), four bolt, quarter-turn ball valve. The base and latch arm can be formed from a variety of materials such as an acetal polymer.

In some embodiments, the catch basin can be disposed under a water heater and configured to displace the latch arm to a point of release in response to about 1 to 2 inches of water (about 25-50 mms) in the catch basin.

The current embodiments also provide a method to shut off a water supply, which can have the steps of: providing a first force in response to unanticipated presence of a fluid; displacing a restrained latch arm connected to a shut-off valve handle past a stop in response to the first force; rotating the shut-off valve connected to a fluid supply by a second force in response to a latch arm displacement beyond a release point. It is noted that the term force as used herein describes the overall weight equivalent of effort acting on the specific element described.

In some methods, the restrained latch arm can be restrained by the second force. In some embodiments, the first force can be provided by a buoyancy force and the second force is provided by a coil spring. The first force can be, for example, up to about 1.5 pounds (about 680 gms) and the second for is at least 18 pounds (about 8200 gms).

According to another approach, an automatic fluid shut-off device, may have a float disposed in a fluid catch basin attached to a first end of a flexible cable movable in an opposite direction of rising fluid in the catch basin; a second end of the movable flexible cable extending into a bore of a spider assembly having a fluid supply and a shut-off valve; the second flexible cable end connected to a first end of a restrained lever arm end of the spider assembly; the lever arm configured to be pivotably displaceable at a second lever arm end upon a force by the second flexible cable end in response to a rising fluid in the catch basin; the lever arm pivoted against a rim of a rachet gear of the spider assembly by a spring, the rachet gear having a pawl to engage and be restrained by a matching indention on the lever arm and the rachet gear turnable on an axis to cause the shut-off valve to rotate to an open and closed position; the shut-off valve retained in an open position while the rachet gear is restrained, and the rachet gear under a rotational force to close the shut-off valve upon a release of the rachet gear pawl from the lever arm in response to the force by the second flexible cable end.

The automatic fluid shut-off device may have the lever arm pivoted against a rim of a rachet gear of the spider assembly by a torsion or an extension spring. The rachet gear rotational force can be generated by a clock spring. The lever arm may be formed from an acetal polymer. The catch basin can be disposed under a water heater and is configured to displace the lever arm to a point of release in response of 25 to 50 mm of water in the catch basin.

A method to shut off a water supply is also provided and may have the steps of providing a first force in response to unanticipated presence of a fluid; displacing a restrained rachet gear in a spider assembly connected to a shut-off valve from a first position past a stop to a second position in response to the first force; rotating the shut-off valve connected to a fluid supply by a second force in response to a rachet gear displacement from the first position to the second position beyond a release point of the rachet gear; and closing the shut-off valve by the second force by overcoming the first position of the restrained rachet gear of the valve to the second released position by a rotational force of a clock spring; and wherein the restrained rachet gear is restrained by a third force holding a lever arm against the rachet gear, which engages a pawl on the rachet gear; wherein the catch basin is disposed under a water heater and is configured to displace the latch arm to a point of release in response of 25 to 50 mm of water in the catch basin.

Other features will become more apparent to persons having ordinary skill in the art to which pertains from the following description and claims.

### BRIEF DESCRIPTION OF THE FIGURES

The foregoing features, as well as other features, will become apparent with reference to the description and figures below, in which like numerals represent elements, and in which:

FIG. 1 is side view of an embodiment of the present devices configured for use with a water heater;

FIG. 2 is a sectional view of an embodiment of the present devices taken along section lines II-II in FIG. 1;

FIG. 3 is a sectional view of an embodiment of the present devices taken along section lines II-II in FIG. 1 upon activation by the float;

FIG. 4 is a top view of an embodiment of the present devices;

FIG. 5 is a side view of an embodiment of the present devices;

FIG. 6a is a detail view of Area VI indicated in FIG. 2, and FIG. 6b is a detail view of Area VIb indicated in FIG. 6a;

FIG. 7 is an alternate embodiment of the present devices configured for use with a water heater;

FIG. 8 is an alternate embodiment of the present device latch arm and base notch;

FIG. 9 is a perspective view of an embodiment of the present devices;

FIG. 10 is a side view of an embodiment of the present devices configured for use with a water heater according to another approach;

FIG. 11 is a perspective view of an embodiment of a shut-off valve assembly of the present devices according to another approach;

FIG. 12 is a perspective view of an embodiment of a shut-off assembly of the present devices according to another approach with its cover removed to show the interior mechanism with a lever arm torsion spring;

FIG. 13 is a perspective cutaway view of the embodiment of FIG. 11, taken along section lines XIII-XIII;

FIG. 14 is a close-up of the perspective exploded view of the spider assembly of the shut-off valve assembly in area XIV of FIG. 15;

FIG. 15 is a perspective exploded view of another shut-off valve assembly of the present embodiments with a lever arm torsion spring;

FIG. 16 is a perspective exploded view of another shut-off valve assembly of the present embodiments with a lever arm extension spring; and

FIG. 17 is a perspective view of an embodiment of a shut-off assembly of the present devices according to another approach with its cover removed to show the interior mechanism with a lever arm extension spring.

### DETAILED DESCRIPTION

The embodiments described below provide mechanical and non-electrical fluid shut-off devices and methods, and specifically fluid shut-off devices and methods using a mechanical action of a float to activate a spring loaded shut-off valve (such as a spring loaded quarter-turn ball valve). In some cases the embodiments can be actuated upon a failure of a fluid reservoir. While the present embodiments are described for a catch basin disposed under a water heater, it is noted that other configurations can be considered within the scope of the presented embodiments. Such configurations could also include any applications involving water supplies and other fluids and gases supplied under pressure, and appliances such as ice-maker water supplies, dishwashers, clothes washers, gas lines, irrigation systems, and the like.

An advantage of the present embodiments is to provide a solely mechanical actuatable shut off valve upon detection of an irregular flow of the fluid or gas. In one instance an event such as raising a rod attached to a float urging an end of a spring loaded paw/latch arm past its retention point to force rotation of a ball valve to shut off the fluid supply. Such a device is not dependant on electrical power supply for actuation.

In one embodiment, the device can shut off the flow of liquid from a float disposed in a catch basin. In use, as unanticipated fluid accumulates in the catch basin, the float rises with the accumulated liquid. As the float rises it can lift a pivoting lever arm acting as a fulcrum. A rod connected at some point along the lever arm lifts with the float and lever arm to apply a force against a latch arm end attached to a handle of a spring loaded valve. As the end of the latch arm rises with the rod, it reaches a release point, allowing a torsion spring to force a valve handle to a closed valve position, thus stopping the flow of any liquid or gas from the supply.

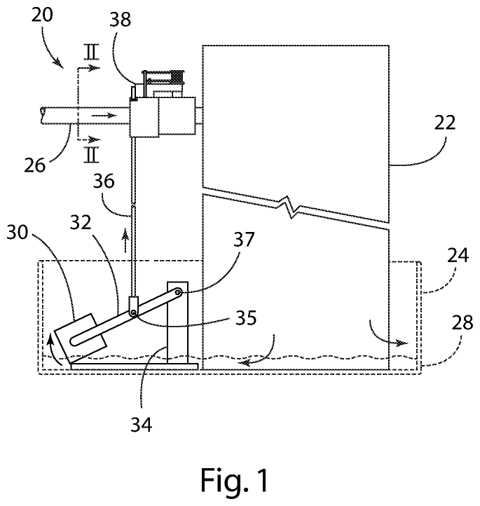

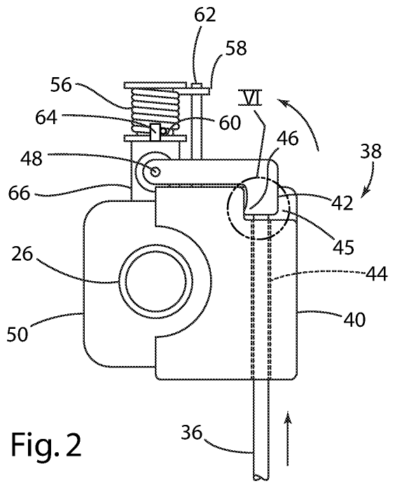

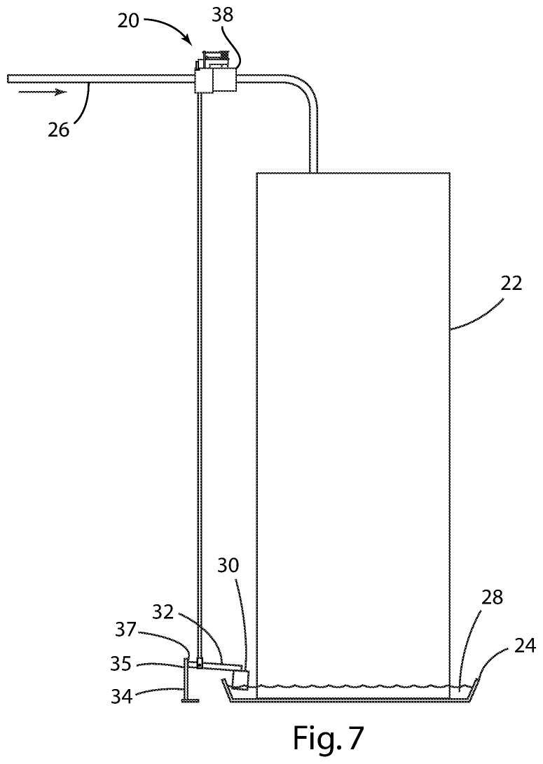

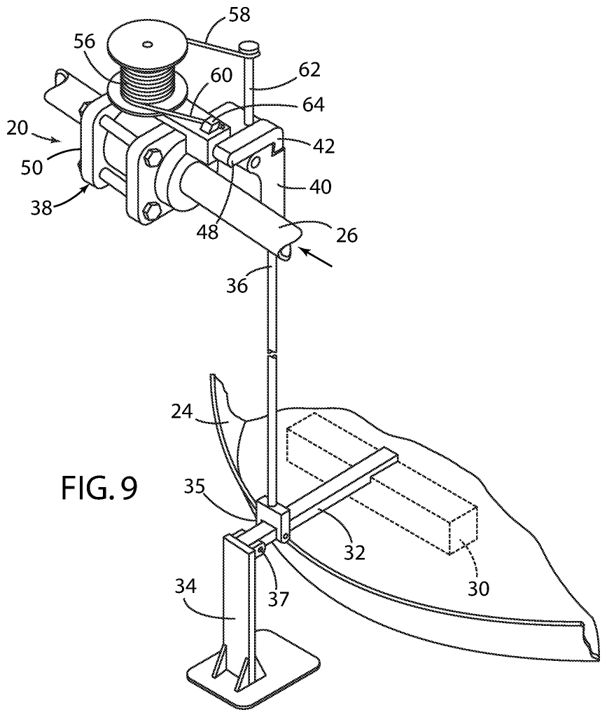

Accordingly, for illustrative purposes only, described herein is one embodiment of the present device configured for use as a shut-off valve for the water supply to a water heater. Turning now to the figures, there is shown an automatic fluid shut-off device generally indicated at 20 (FIG. 1). As shown, a fluid 28 is fed to a fluid reservoir, such as a water heater 22, by a fluid/water supply 26. Surrounding the bottom of water heater 22 a catch basin 24 can be provided to receive fluid, such as upon failure of the fluid reservoir 22. In one embodiment, such as shown in FIG. 7, catch basin 24 can have a depth in the range of up to the height of the reservoir, but preferably about 2.5 (about 64 mms) to 3.5 inches (about 89 mms), though many variations are possible within the scope of the present embodiments. Catch basin 24 can have a variety of shapes and sizes and made from a variety of materials such as plastics, ceramics, glass, masonry, and the like. In some embodiments catch basin 24 can even be a perimeter damn formed around the fluid reservoir. The size of the catch basin should be limited to allow for a minimal ‘footprint’ on the floor where water heater 22 is located. For example, in one embodiment, catch basin 24 can have an interior diameter about 4 inches (about 100 mms) greater than the outer diameter of the water heater. In this example, catch basin 24 would have a clearance of a minimum of two inches (about 50 mms) outside of the perimeter of water heater 22.

As shown in FIGS. 1 and 7, a fulcrum arm 32 is pivotally hinged to a base 34 at pivot 37. For illustrative purposes only, in one embodiment base 34 can stand at about 4.4 (about 112 mms) inches in height. Base 34 can be formed from a variety of rigid materials to provide stability to the lever action of the float and can be fixed to the floor or within the catch basin (FIG. 1), attached to the wall of the catch basin (not shown), or outside of the catch basin (FIG. 7. Again, for illustrative purposes, the length of fulcrum arm 32 can be about 5.5 (about 140 mms) inches. In this embodiment, at about ¾″ (about 19 mms) from the axis point 37 of fulcrum arm 32 to base 34, a pivot point 35, such as a hinged clevis, is attached. At the distal end of the fulcrum a float 30 is attached. Float 30 can be formed from a variety of materials configured to be buoyant relative to the fluid 28. For example, where fluid 28 is water, the float can be made from cork, wood, closed cell foams (such as a closed cell extruded polystyrene foam sold under the trade name STYROFOAM), and the like. In embodiments using a closed cell STYROFOAM, float 30 can have a volume of about 16.5 square inches (420 sq mms) and/or measure about 1.5″ (38 mms) wide, about 5.5″ (140 mms) long, and about 2″ (51 mms) high. In any event, the float should be able to generate approximately at least about one (1) pound (about 450 gms) of lift force (buoyancy) when submerged in the fluid/water.

As the more lift is applied to float 30 at the end of fulcrum arm 32, pivot point on fulcrum arm to rod 36 can be configured to be at a point where the transferred force provides about six pounds (about 2700 gms) of lift. Accordingly, at point 35, a rod 36 is disposed along the length of the fulcrum arm 32 so that 6 pounds (about 2700 gms) of lift can thus be applied to rod 36. In other words, rod 36 is positioned at a point of the fulcrum arm such that 6 times the buoyant force of the float is applied. In another example, rod 36 can be positioned on fulcrum arm such that the force ultimately applied to a latch arm (see below) can be, for example, up to about 1.5 pounds (about 680 gms). Ultimately, the force applied would be sufficient to release the latch arm. This desired force would need to consider several factors such as the friction of all the components, the weight of the components (e.g., the weight of rod 36), the potentially predicted buildup of dust/debris that may occur among the components over time, and the like.

Attached to the clevis is a rod 36. Rod 36 can be any rigid rod that can transfer the buoyant force of the float to the shut-off assembly as described below. Rod diameter, length, weight, density, desired rigidity and cost can be configured for specific applications. For example, rods can be formed from stainless steel, carbon fiber, wood, plastics, other types of steel (such as a typical number 8 threaded metal rod) can be used. Rod 36 extends from the clevis 35 toward a shut off valve assemble 38. Positioning, securing and protecting rod 36 can be achieved by sleeves and guides along its length (not shown).

Shut-off valve assembly 50 can include a shut off valve such as a handle activated ¾″ (about 19 mms), four bolt, quarter-turn ball valve. While the shut-off valve is described for a quarter-turn ball valve, it is noted that other types of shut-off valves could also be within the scope of the present embodiments. Exemplary shut-off valves could also include: butterfly valves, gate valves, piston valves, and the like.

The actuation assembly 38 components, as shown, can be bolted onto valve 50. Assembly 38 can provide a valve assembly shut-off base 40 that has a guide (as shown a valve assembly rod guide with a rod arm bore 44) for rod 36 to travel freely through and to guide rod 36 to a latch arm 42. An area of base 40 can have a notch cutout 45 at the guide hole. Base 40 and latch arm 42 can be formed of a variety of materials including metals and plastics. For example, plastic embodiments can include acetal polymer materials, such as one sold under the trade name DELRIN. As shown, base 40 is ‘upstream’ in the fluid supply of shut off valve 50. It is noted though that the present embodiments can be practiced so the base 40 can be on either side of shut off valve 50.

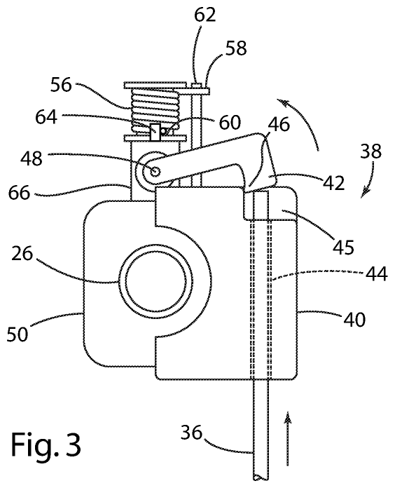

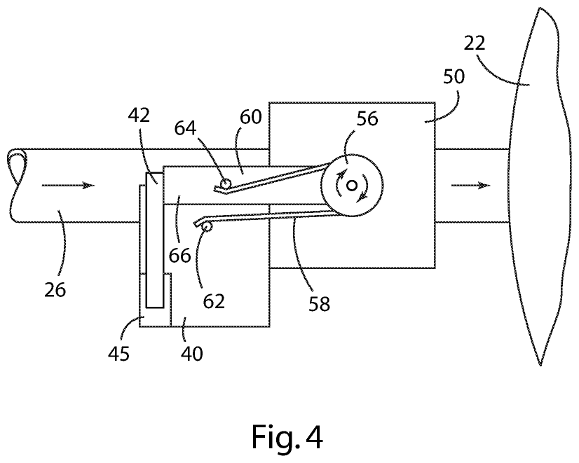

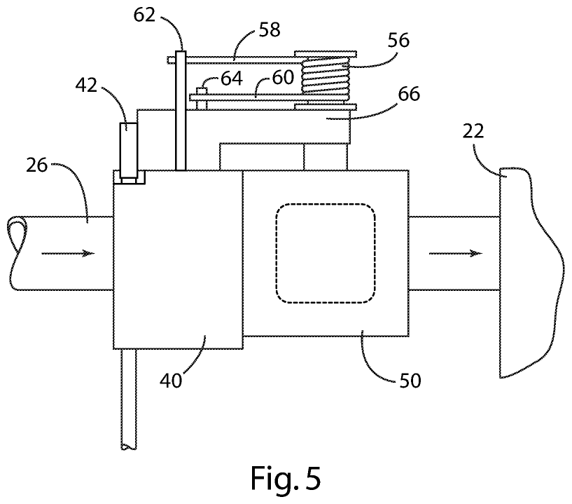

As shown in FIG. 3, as rod 36 rises, such as in response to a rising float in a catch basin, rod 36 end applies the rising force against an end of latch arm 42. As latch arm 42 is displaced upward, it rotates about a latch arm axis point 48 that is connected to the end of a handle 66, which as shown is rotatable against an axis perpendicular to the pivot of latch arm 42. Handle 66 turning about its axis cause valve 50 to rotate to an open or closed position. When latch arm 42 is held in place by shut-off base notch 45, valve 50 is maintained in an open position to allow flow of fluid through the water supply 26.

As latch arm is displaced and extends beyond shut-off base notch 45, handle 66 is under a rotational force to close by a torsion spring 56 mounted, in this illustration above valve 50. It is noted though that some embodiments can be configured to employ a coil spring, though a torsion spring is preferred as it allows for a more efficient, cost effective and compact design. The ends 58 and 60 of torsion spring 56 are preferably in a generally parallel orientation held in place by raised stops 64 and 62 respectively on handle 66 and a rod anchored by the base 40. The torsion spring 56 can be formed from a variety of materials such as music wire with a diameter of 0.105 inches, and free position of ends turning radius of 360 degrees. Torsion spring 56 can be wound about a spool, for example, a 1 and ⅜″ spool (i.e., about 35 mms). In any event, torsion spring must be able to provide enough force to rotate valve 50 in the presence of the fluid under pressure. For most embodiments, torsion spring 56 should be able to generate at least 18 pounds (about 8164 gms) of force. In one embodiment, torsion spring 56 can generate about 21 lbs (about 9500 gms) of force.

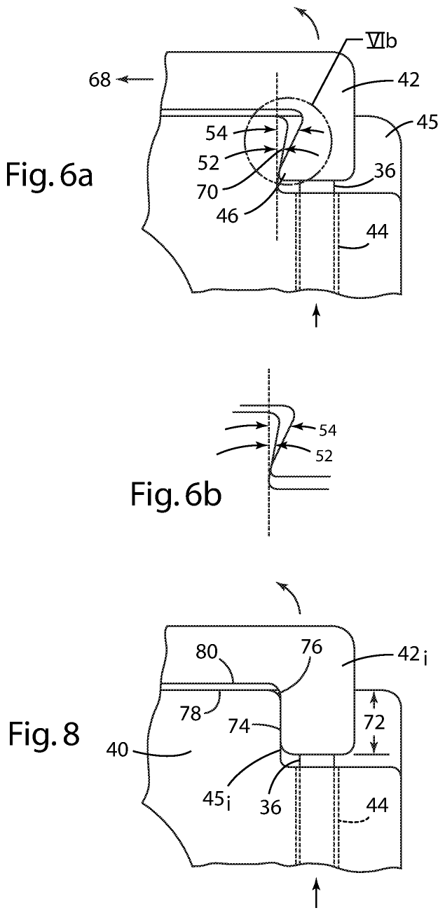

Returning to the latch arm, as described above, disposed at the end of handle 66 a pivotable (at 48) latch arm 42. Latch arm 42, as shown, is “L” shaped and rests in cutout notch 45 in base 40 as shown in FIG. 6. Again, cutout notch 45 and the ‘L’ shaped latch arm 42 are made from a material that is strong enough to hold the full force of the spring tension and have a low coefficient of friction to allow latch arm to be displaced upward under the rising force of rod 36. Latch arm 42 and notch 45 are also configured by their angular orientation to retain the latch arm 42 at the bottom of notch 42.

As shown most clearly in FIG. 6, latch arm 42 can be held in place under the force of the torsion spring in the direction shown at 68. Latch arm 42 can optionally have an angle 54 (such as a 5.5 degree angle). An angle 52 (such as about a 3.5 degree angle) can also be optionally formed on side wall 70 contact surface of cutout notch 45 on base 40 to drive the latch arm apex point 46 in and down along the side wall 70 until it reaches a point where it can be positioned approximately adjacent to the end of rod 36 to allow engagement as rod 36 raises. With the force at these contact surfaces, the angles provide a desired downward pull configuration on the latch arm to prevent its inadvertent release. Given the pre-configured angles and coefficient of friction, the force needed to move the latch arm 42 above side wall 70 can be calculated with predictability. Further angle 54 can be configured to provide clearance as it traverses upward along side wall 70.

An alternate latch arm retention configuration is illustrated in FIG. 8. As shown, latch arm 42i edge 76 is held against base 40i on its side wall 74. Edge 76 and sidewall 74 are generally parallel and at right angles to latch arm lower edge 80 and base top 78 respectively. The right angles allow ease of manufacturing, such as for injected molded plastic components. It is noted that the end portion of the “L” of latch arm 42i is configured to be a length 72 to allow a preconfigured force (such as at least 1.5 pounds of force) to overcome the friction between surfaces 74 and 76 and allow the latch arm to swing upward from the force generated by the raising of rod 36.

Accordingly, in use, as fluid reservoir 24 fills with fluid 28, float 30 is lifted. Float 30 raises the end of lever arm 32 acting as a fulcrum lifting rod 36. As rod 36 raises, it applies force to end of latch arm 42 to overcome the down and inward force of the torsion spring 56 provided by angles 54 and 52. Upon the latch arm end reaching the top edge of side wall 70, the full force of torsion spring 56 is released to rotate valve handle 66 from an open position to the closed position.

A clear advantage of the current device is that it is totally mechanical. The device can also be custom fitted to any size water heater without major re-routing of plumbing. It can be configured to trigger with a water lever of about 0.5-2 inches (about 12 to 50 mms) within the catch basin. Optimally the device is made from materials that resist corrosion and wear such as material sold under the trade name of DELRIN.

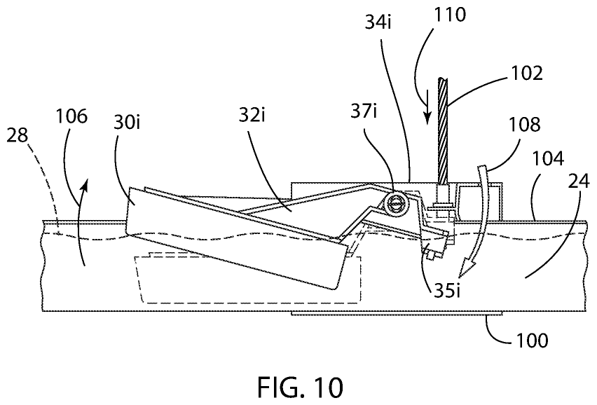

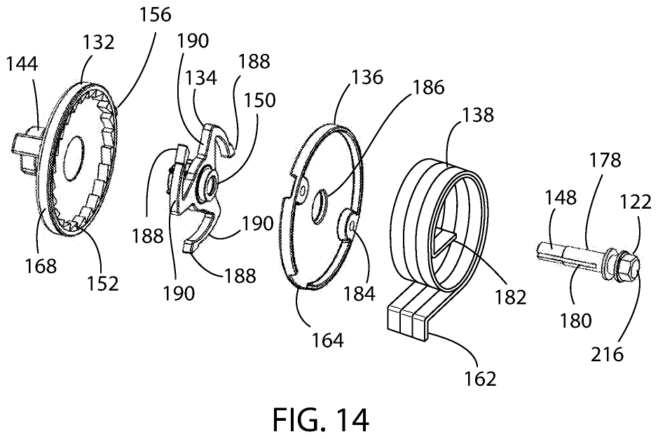

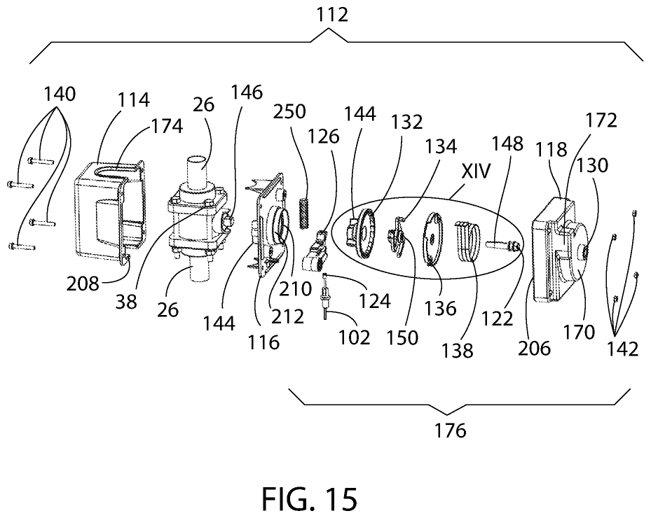

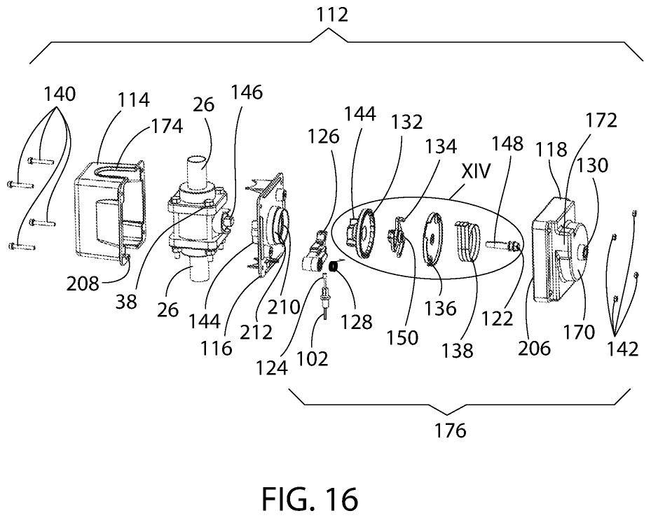

An alternate embodiment of an automatic fluid shut-off device is provided in FIGS. 10-17. In this approach an automatic fluid shut-off device is provided having a float disposed in a fluid catch basin attached to a first end of a flexible cable movable in an opposite direction of rising fluid in the catch basin; a second flexible cable end extending to a fluid supply base and terminating adjacent to a restrained spider/racket gear assembly, the spider assembly configured to be rotationally displaceable upon a force by the second flexible cable end in response to a rising fluid in the catch basin; the spider assembly rotatably connected to a shut-off valve; and the shut-off valve retained in an open position while the spider assembly is restrained, and under a rotational force to close the shut-off valve upon activation of the spider valve in response to the force by the second flexible cable end. Dimensions, materials, forces and the like may be comparable to other embodiments described herein.

FIG. 10 shows a side view of an embodiment of the present devices configured for use with a water heater according to another approach. In this embodiment, the float assembly can be connected to the valve assembly by a rod 36. However, as shown the float assembly can be connected to the valve assembly by, for example, a flexible cable 102 which activates closures of the fluid supply by pulling on the mechanism to trigger closure of the valve to stop the fluid supply. Cable 102 may be formed by a variety of materials that are flexible yet strong enough to pull lever arm 126 against the torsion spring 128. Metal cable, strong plastic straps and the like may be used. In this embodiment, a fulcrum arm 32i is pivotally hinged to a base 34i at pivot 37i. For illustrative purposes only, in one embodiment base 34i can stand at about 4.4 (about 112 mms) inches in height. Base 34i can be formed from a variety of rigid materials to provide stability to the lever action of the float. Base 34i may be fixed to the floor or within the catch basin or attached to the wall of the catch basin. As shown in FIG. 10, base 34i is outside of catch basin 24 and has a tab 100 disposed under fluid reservoir/catch basin 24 to hold it in position. This configuration allows for quick and simple installation. Again, for illustrative purposes, the length of a fulcrum arm 32i can be about 5.5 (about 140 mms) inches. In this embodiment, at about ¾″ (about 19 mms) from the axis point 37i of fulcrum arm 32i to base 34i, a pivot point 35i, such as a hinged clevis, may be attached. Alternately, given the flexibility of cable 102, a pivot is optional at this connection.

Attached to fulcrum arm 32i, a float 30i is attached. Float 30i can be formed from a variety of materials configured to be buoyant relative to the fluid 28. Alternatively, fulcrum arm 32i itself may be made from a buoyant material. For example, where fluid 28 is water, the float can be made from cork, wood, closed cell foams (such as a closed cell extruded polystyrene foam sold under the trade name STYROFOAM), and the like. In embodiments using a closed cell STYROFOAM, float 30 can have a volume of about 16.5 square inches (420 sq mms) and/or measure about 1.5″ (38 mms) wide, about 5.5″ (140 mms) long, and about 2″ (51 mms) high. In any event, the float should be able to generate approximately at least about one (1) pound (about 450 gms) of lift force (buoyancy) when submerged in the fluid/water. Alternatively, based on the configuration of the mechanism to trigger the automatic shut-off, float 30i must be able to provide enough downward force on flexible cable 102 to actuate the shut-off mechanism before the fluid level reaches the top rim 104 of fluid reservoir 24.

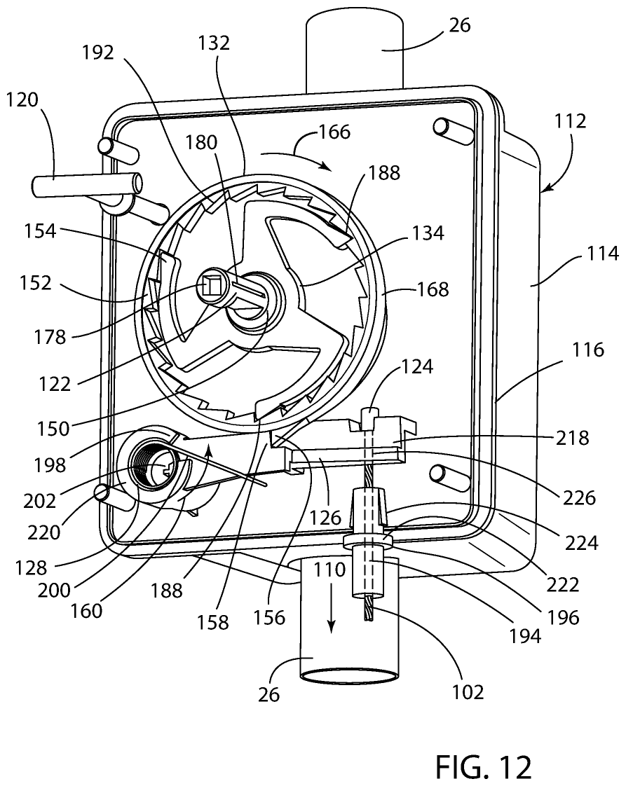

Accordingly, in use, as fluid reservoir 24 fills with fluid 28, float 30i is lifted (See direction 106). Float 30i lowers (See 108) the end of lever arm 32i acting as a fulcrum pulling flexible cable 102 downward (See 110 in FIGS. 10 and 12). As described below, as flexible cable 102 lowers, it applies force to shut-off assembly to overcome force of its torsion spring. Upon the assembly reaching a predetermined position, the full force of torsion spring 56 is released to rotate ball valve from an open position to the closed position.

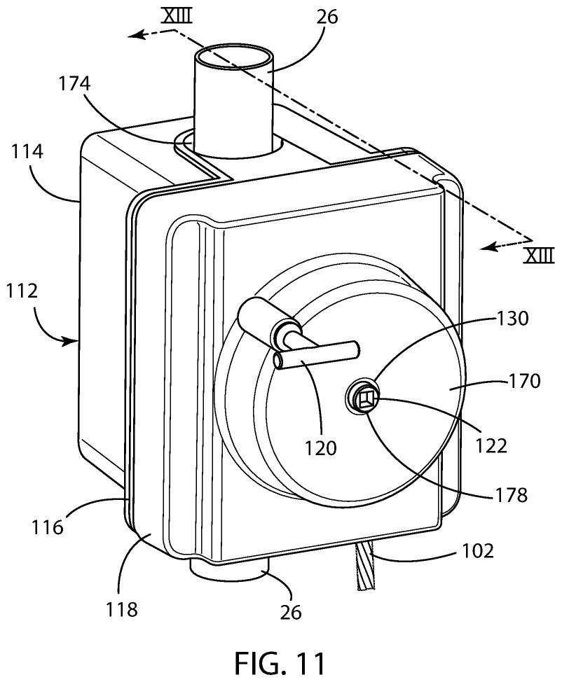

FIGS. 11-17 show an alternate automatic shut-off valve assembly 112 according to the present embodiments. Automatic shut-off valve assembly 112 housings are preferably rigid and made from a variety of materials including plastics, ceramics, metals, composites, and the like and combinations thereof.

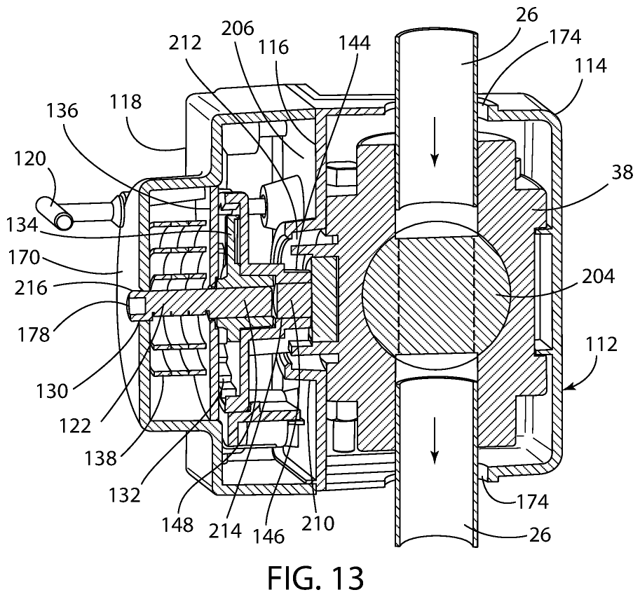

As shown, shut-off valve assembly 112 may have a housing 114 to house an installed shut-off valve 38 (e.g., a valve body nest) to water supply 26. As previously described, the shut-off valve can be a ball valve as described herein such as one sold under the tradename BANJO BALL VALVE by Banjo Valves and Fittings—Alsco Industrial Products, Inc. The shut-off valve can be a ¾″ (about 19 mms), four bolt, quarter-turn ball valve. The base can be formed from a variety of materials such as an acetal polymer. The quarter turn allows for full open to full closed positions. In its normal state the present embodiments maintain the ball in the open position such as shown in FIG. 13. Portions ball valve housing 114 are configured to have openings 174 to allow for the water supply 26 to pass through the assembly when assembled.

Assembly 112 may also have a spider HSC standoff/interface 116 to cover shut-off valve 38 and an open end 208 of housing 114. As shown, interface 116 has a standoff 210 with an opening 212 to receive hub 144 of rachet gear 132.

Assembly 112 also has a housing 118 to contain the automatic shut-off mechanism 176. Housing 118 has an opening 130 to provide access to the end of pin 122 on one side and an opening 206 to receive the shut-off valve assembly on the other. Housing 118 also has an opening to hold a fitting 196, which has a hole 194 to allow passage of flexible cable 102, in which cable 102 continues through passage 226 of lever arm 126. Fitting 196 is held in place by a flange 222 on one side of housing 118 and expanding tabs 224 on the other side of housing 118.

As shown, cable 102 extends through lever arm 126 and has a flange 124 to apply force to lever arm 126. As shown, housing 118 may have a portion 170 to house the clock spring (torsion spring) 138 as well as a clock spring first end stop 172 to hold the first end clock spring 162 from rotation when tensioned.

As shown in FIGS. 11 and 12, an optional handle 120 is configured to be a locking pin to hold the clock spring 138 in place prior to installation. After the assembly 112 is installed on the water supply, the installer can pull locking pin 120 to activate the clock spring within the device.

Ball valve housing 114, ball valve cover/Spider HSG standoff 116 and automatic shut-off assembly housing 118 can all be held together by bolts 140 extending through matching holes in each and held in place by nuts 142 disposed on a boss on automatic shut-off assembly housing 118. Other alternative configurations are possible to hold the components of assembly 112 in place. Once assembled, the valve assembly 112 surrounds and is supported by the water supply and or/ball valve 38.

The ‘spine’ of shut-off assembly 176 is a pin 122. Pin 122 can take many forms, but it must be able to rotate and provide a rotational force, for example, by being secured to spring 138 and a first end 216, through to a recess 150 of a three-armed pawl 134 (spider gear) at a second end 148. Pin 122 can lock into recess 150 by many means such as a square end of pin 122 to a matching square recess 150. Ultimately, the assembly transfers the rotational force to hub 144 of rachet gear 132, which is configured to provide sufficient force to instantaneously rotate ball valve 38 to a closed position when triggered. Hub 144 receives a matching shaft post 146 of valve 38 connected to rotate ball 204. For example, if shaft 146 is square, the opening of recess 214 matches its shape and dimension. Also, pin 122 may have a recess 178 (See, e.g., FIG. 13) at its first end 216 to receive a drive or wrench to provide force to install the pin into the device.

Thus, automatic shut-off valve assembly 112 receives its torque to rotate the ball in valve 38 by a clock/torsion spring 138 disposed within housing 118. A first end 162 of torsion spring 138 is held in place within housing 118 at a first end stop portion 172. A second end 182 of torsion spring 138 may be, for example, received within a slot 180 of pin 122. Other configurations are possible to retain second end 182 on to pin 122. Torsion spring 138 is contained within housing 118 by a cover 136, which for example, may be held onto housing 118 through fasteners disposed through holes 184. Cover 136 also has an opening 186 to allow pin 122 to extend therethrough. Cover 136 may optionally have an opening 164 or tabs or ribs to also restrain first end 162 of torsion spring 138.

Portion 148 of rotatable pin 122 extends through cover 136 and through recess 150 of three arm pawl (spider gear) 134. Three arm pawl 134 has three pawls 188 attached to flexible arms 190. Three arm pawl 134 may be made a rigid material such as metal or rigid plastic yet provide flexibility to allow the arms bend to the height of a pawl so that it may be rotated in this configuration in a counter clockwise fashion if a configuration needed that functionality. This feature is used when an installer rotates the three-armed pawl 134 counterclockwise to load/increase the tension in the clock gear to the point that it has enough torsion to rotate the ball gear to a closed position. In any event, three-armed pawl 134 must be able to engage gear teeth 152 of rachet gear 132 which is rotatably mounted (shown as clockwise at 166) to shaft 146 of valve 38.

Thus, without additional restraint, shut-off assembly 112 maintains a closed position of valve 38 in its natural state. In the present embodiments, this closed state is maintained unless there is a manual override to an open state or that the float basin is positioned to indicated that the catch basin 24 is at a preconfigured level (e.g., empty). Float 30 or 30i transfers its position in this alternative embodiment through flexible cable 102.

As shown in, for example, FIG. 12 flexible cable 102 is attached to a first end 218 of a lever arm 126. At a second end 220, lever arm 126 is pivotably attached to ball valve cover 116 at 202. A first end 200 of a torsion spring 128 at pivot 202 is connected to and extends through a notch 198 on lever arm 136. Notch 198 is configured to receive first end 200 of spring 128 which terminates in a bend under lever arm 126. A second end of torsion spring 128 is connected to ball valve cover 116. Thus, when tensioned, torsion spring 128 drives lever arm 126 in a direction 160, which is against the rachet gear rim 168.

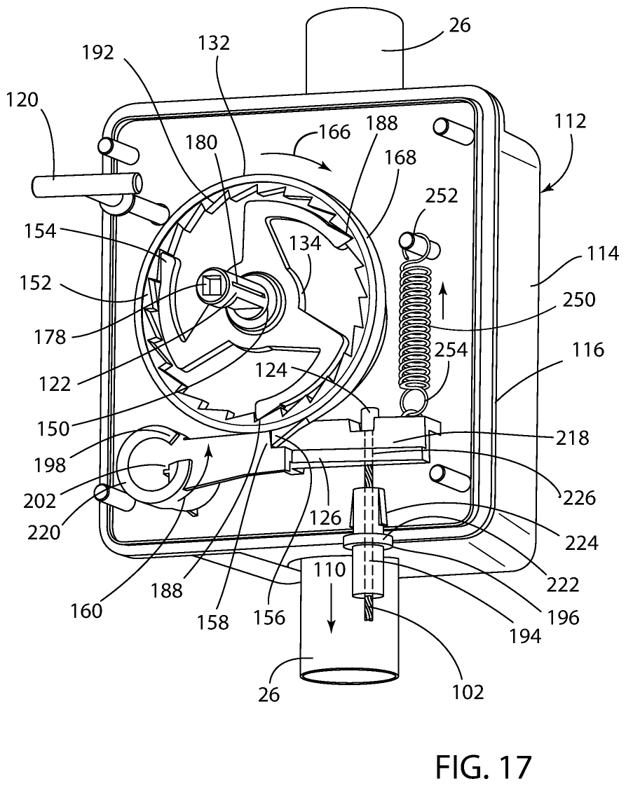

In an alternate embodiment shown in FIG. 17, an extension spring 250 is used instead of a torsion spring to drive lever arm 128 in a direction 160, which is against the rachet gear rim 168. Extension spring 250 attaches to first end 218 of a lever arm 126 at attachment 254 and mounts to assembly 112 at mount 252.

Rachet gear rim 168 has a pawl 156 which as shown is configured to be in position to maintain valve 38 in an open position (e.g., shown here as at 6 o'clock). However, clock spring 138 is configured to keep pawl 156 in a 9 o'clock position (i.e., at a quarter turn difference to closed position). To maintain pawl 156 in a 6 o'clock position (i.e., at an open position), pawl 156 engages an indentation 158 of lever arm 126. Since torsion spring 128 or extension spring 250 maintains lever 126 at its position as shown in FIG. 12, rachet gear 132 maintains its 6 o'clock position, thus leaving the valve 38 open. It is only when the force of torsion spring 128 is overcome by a downward force of flexible cable 102 that lever arm 126 is pulled away from the rachet gear rim 168, thus freeing pawl 156. The force of clock spring then allows rachet gear 132 to rotate hub 144 to close valve 38. It is noted that the positions of the pawls and lever arm are illustrative of just one way to practice the current embodiment. The time to close the ball valve when triggered is close to instantaneous.

### REFERENCES NUMBERS FOR THE ALTERNATE EMBODIMENT

38 quarter turn ball valve
102 flexible cable 102
110 downward movement of flexible rod 102
112 alternate automatic shut-off valve assembly
114 ball valve housing
116 ball valve cover/Spider HSG standoff
118 automatic shut-off assembly housing
120 lock out pin
122 pin
124 flange to hold flexible cable 102 to lever arm 156
126 lever arm
128 lever arm 126 torsion spring
130 housing 118 opening for pin 122
132 rachet gear
134 three armed pawl
136 torsion spring cover
138 torsion/clock spring
140 housing bolts
142 housing nuts
144 hub of rachet gear to rotate closure of ball valve
146 post to receive rotational force from matching recessed portion of gear 144 of automatic shut-off valve assembly
148 second end of pin 122
150 three arm pawl opening
152 rachet gear tooth
156 exterior pawl of rachet gear 132
158 indent of lever arm 126 of exterior pawl of rachet gear 132
160 rotation of lever arm 126
162 first end clock spring
164 slot on torsion spring 138 cover
166 rotation of racket gear
168 rachet gear rim
170 clock spring housing
172 clock spring first end stop (spring tension stop)
174 water supply openings in housing 114
178 pin recess
180 pin slot
182 second end clock spring
184 cover 136 holes
186 cover 186 opening to allow pin 122 to extend therethrough
188 pawl of 134
190 flexible arm of pawl 188
192 rachet gears
194 opening of fitting 196 to allow slidable passage of cable 102
196 fitting to guide cable 102
198 notch on lever arm to receive first end 200 of spring 128
200 first spring end of spring 128
202 Rotational pivot of lever arm 126
204 ball
206 housing 116 opening to receive hub 144
208 open end of housing 114
210 stand off
212 stand off opening
214 recess in hub 214
216 first end of pin 122
218 first lever arm end
220 second lever arm end
222 flange for fitting 196
224 expanding tabs to hold fitting 196 in opening of housing 118 with flange 222
226 lever arm bore to allow passage of cable 102
250 extension spring
252 extension spring connection to assembly
254 extension spring connection to lever arm 126.

While the products and methods have been described in conjunction with specific embodiments, it is evident that many alternatives, modifications, and variations will be apparent to those skilled in the art in light of the foregoing description.

1.-13. (canceled)

14. An automatic fluid shut off device, comprising:
a float disposed in a fluid catch basin attached to a first end of a flexible cable movable in an opposite direction of rising fluid in the catch basin;
a second end of the movable flexible cable extending into a bore of a spider assembly having a fluid supply and a shut-off valve;
the second flexible cable end connected to a first end of a restrained lever arm end of the spider assembly;
the lever arm configured to be pivotably displaceable at a second lever arm end upon a force by the second flexible cable end in response to a rising fluid in the catch basin;
the lever arm pivoted against a rim of a rachet gear of the spider assembly by a spring, the rachet gear having a pawl to engage and be restrained by a matching indention on the lever arm and the rachet gear turnable on an axis to cause the shut-off valve to rotate to an open and closed position;
the shut off valve retained in an open position while the rachet gear is restrained, and the rachet gear under a rotational force to close the shut-off valve upon a release of the rachet gear pawl from the lever arm in response to the force by the second flexible cable end.

15. The automatic fluid shut off device of claim 14, wherein the lever arm is pivoted against a rim of a rachet gear of the spider assembly by a torsion spring.

16. The automatic fluid shut off device of claim 14, wherein the lever arm is pivoted against a rim of a rachet gear of the spider assembly by an extension spring.

17. The automatic fluid shut off device of claim 14, wherein the rachet gear rotational force is generated by a clock spring.

18. The automatic fluid shut off device of claim 14, wherein the lever arm is formed from an acetal polymer.

19. The automatic fluid shut off device of claim 14, wherein the catch basin is disposed under a water heater and is configured to displace the lever arm to a point of release in response of 25 to 50 mm of water in the catch basin.

20. A method to shut off a water supply, comprising the steps of:
providing a first force in response to unanticipated presence of a fluid;
displacing a restrained rachet gear in a spider assembly connected to a shut-off valve from a first position past a stop to a second position in response to the first force;
rotating the shut-off valve connected to a fluid supply by a second force in response to a rachet gear displacement from the first position to the second position beyond a release point of the rachet gear; and
closing the shut-off valve by the second force by overcoming the first position of the restrained rachet gear of the valve to the second released position by a rotational force of a clock spring;
wherein the restrained rachet gear is restrained by a third force holding a lever arm against the rachet gear, which engages a pawl on the rachet gear; and
wherein the catch basin is disposed under a water heater and is configured to displace the latch arm to a point of release in response of 25 to 50 mm of water in the catch basin.
